(19) United States
(12) Patent Application Publication
(10) Pub. No.: US 2003/0113458 A1
(43) Pub. Date: Jun. 19, 2003

(54) Method for increasing absorption rate of aqueous solution into a basesheet

(75) Inventors: Daniel Hoo, Appleton, WI (US); Brian James Gingras, Appleton, WI (US); Clayton Taylor Gann, Appleton, WI (US); Robert Eugene Krautkramer, Kaukauna, WI (US); Anthony Mark Gambaro, Appleton, WI (US); James Monroe Perkins, Appleton, WI (US)

Correspondence Address: Glen P. Belvis, Brinks Hofer Gilson & Lione, P.O. Box 10395, Chicago, IL, 60610, US

(73) Assignee: Kimberly Clark Worldwide, Inc.

(21) Appl. No.: 10/024,999

(22) Filed: Dec. 18, 2001

(51) Int. Cl. B05C 11/02; B05C 5/00; B05D 3/12

(52) U.S. Cl. 427/365; 118/117; 118/244; 118/300

(57) ABSTRACT

A method of wetting a web of material is described, which in general provides for applying a wetting solution to the web, and passing the web of material between a set of press rolls. The wetting solution may be applied at an add-on greater than 25%, and the web may travel at a speed of at least 60 meters per minute.

### BACKGROUND OF THE INVENTION

Wet products such as wet wipes have many applications. They may be used with small children and infants when changing diapers, they may be used for house hold cleaning tasks, they may be used for cleaning hands, they may be used as a bath tissue, they may be used as by a caregiver to clean a disabled or incontinent adult, or they may be used in and for a whole host of other applications, where it is advantageous to have a wipe or towel that has some moisture in it.

Wet wipes have been traditionally been made in processes in which larger webs of wipes are initially made, and then these larger webs are converted into smaller rolls or sheets that can be placed in a dispenser. Embodiments of dispensers are described in application Ser. Nos. 09/565,227 and 09/545,995; in application Ser. Nos. 09/659,307; 09/659,295; 09/660,049; 09/659,311; 09/660,040; 09/659,283; 09/659,284; 09/659,306, filed Sep. 12, 2000; in application Ser. No. 09/748,618, filed Dec. 22, 2000; in application Ser. No. 09/841,323, filed Apr. 24, 2001; in application Ser. No. 09/844,731, filed Apr. 27, 2001; and in application Ser. No. 09/849,935, filed May 4, 2001, the disclosures of which are incorporated herein by reference.

Wet wipes can be any wipe, towel, tissue or sheet like product including natural fibers, synthetic fibers, synthetic material and combinations thereof, that is wet or moist. Examples of wet wipes are disclosed in application Ser. Nos. 09/564,449; 09/564,213; 09/565,125; 09/564,837; 09/564,939; 09/564,531; 09/564,268; 09/564,424; 09/564,780; 09/564,212; 09/565,623 all filed May 4, 2000; in application Ser. No. 09/223,999, filed Dec. 31, 1998; and in application Ser. No. 09/900,698, filed Jul. 6, 2001, the disclosures of which are incorporated herein by reference.

There is a need for improved methods for making wet wipes and for wetting the web material which is used to make wet wipes. Typically, wet wipes are manufactured as a roll or stack of dry sheets, which are then soaked in a wetting solution. Among other disadvantages, this method can lead to undesirable variations in the properties and performance of the wipes. It is desirable to manufacture wet wipes such that the wetting solution and its ingredients are uniformly distributed throughout the web material as well as the final product. It is also desirable for the web material to have a high moisture content, but without the presence of excess liquid on its surface, especially during the processing of the wetted sheet.

### BRIEF SUMMARY OF THE INVENTION

In an embodiment of the invention there is provided a method of wetting a web, comprising providing a hydrophobic web of material comprising a water-dispersible binder; applying a wetting solution to the web; and passing the web between a pair of press rolls. These embodiments may further comprise a method wherein the wetting solution is applied at an add-on greater than about 25%; the wetting solution is applied at an add-on greater than about 100%; the wetting solution is applied at an add-on between about 25% and about 700%; the web retains a solution add-on greater than about 25%; the web travels at a speed of at least 60 meters per minute; the web comprises a water-dispersible binder; the web is hydrophobic; the web of material has a conventional add-on, and the wetting solution is applied at an add-on which is at least 15% greater than the conventional add-on; and wherein the wetting solution is applied at an add-on which is at least 25% greater than the conventional add-on. These embodiments may yet further comprise a method comprising passing the web between a second pair of press rolls.

In an embodiment of the invention there is provided a method of wetting a web, comprising providing a web of material from a source; controlling the draw of the web from the source; perforating the web; positioning the perforated web between a pair of press rolls; and applying a wetting solution to the press rolls with an add-on of at least about 25% to yield a wet web; wherein the wet web retains a solution add-on greater than about 25%.

These embodiments may further comprise a method wherein the wetting solution is applied at an add-on between about 25% and about 700%; the wetting solution is applied at an add-on greater than about 100%; the web travels at a speed of at least 60 meters per minute; the web comprises a water-dispersible binder; the web is hydrophobic; and wherein the web of material has a conventional add-on, and the wetting solution is applied with an add-on which is at least 25% greater than the first add-on. These embodiments may yet further comprise a method comprising passing the web between a second pair of press rolls.

In an embodiment of the invention there is provided an apparatus for wetting a substrate, comprising a pair of press rolls; and a solution applicator which delivers a wetting solution to a hydrophobic web comprising a water-dispersible binder; wherein the web passing between the press rolls can absorb the solution with an add-on of at least about 25%.

These embodiments may further comprise an apparatus, wherein the solution applicator is a spray boom; the solution applicator is a drool bar; the apparatus further comprises a fluid distribution header; the press rolls are nipped; the press rolls are separated by a distance of about 0.01 mm to about 1.0 mm; each roll comprises a cover having a hardness of about 70 to about 95 Shore A durometer; the web has a conventional add-on, and the web passing between the press rolls can absorb the solution at an add-on which is at least 25% greater than the conventional add-on; wherein the apparatus further comprises a second pair of press rolls; wherein the solution applicator delivers the wetting solution directly to the web; and wherein the solution applicator delivers the wetting solution by depositing the solution onto the press rolls.

### BRIEF DESCRIPTION OF THE DRAWINGS

FIG. 1 is a diagrammatic view of an apparatus connected to a parent roll.

FIG. 2 is a diagrammatic view of the wetting apparatus of FIG. 1.

FIG. 3 is a diagrammatic view of housings for the wetting apparatus of FIG. 2.

FIG. 4 is a diagrammatic view of a wetting apparatus with press rolls.

FIG. 5 is a diagrammatic side view of a spray boom.

FIG. 6 is a diagrammatic front view of a spray boom.

### DETAILED DESCRIPTION

A method for increasing the absorption rate of an aqueous solution into a web is provided which in general includes applying a wetting solution to a web of material, and passing the web between a pair of press rolls. The method may provide for increased add-on of the wetting solution while minimizing or eliminating any excess liquid on the surface of the sheet. An apparatus for performing the method is also provided.

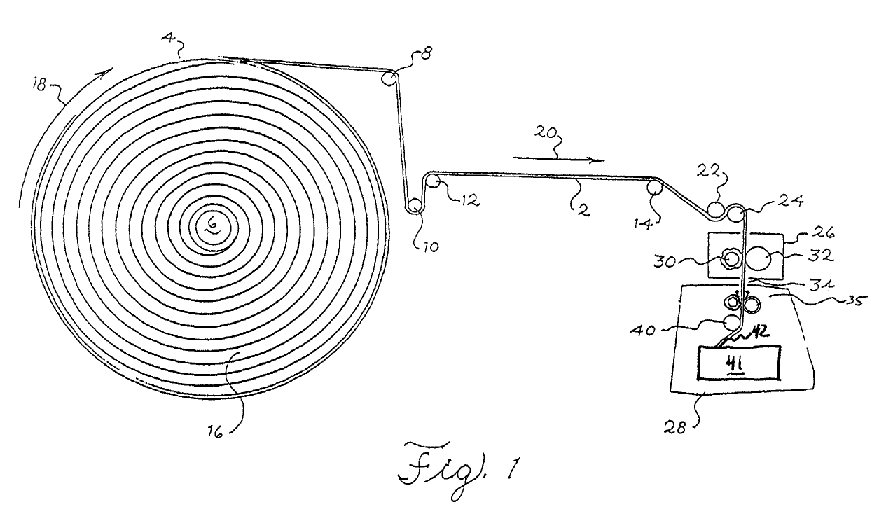

Referring to FIG. 1, there is in general provided a web of material 2. This source web may be any type of basesheet known to those skilled in the art. For example, the web may be a wet-formed basesheet such as a tissue or towel basesheet. The web may be a non-woven basesheet, such as an airlaid, spun-laid, hydroentangled, spun-bond, or melt-blown basesheet. The web may be a multi-layer basesheet, such as a laminate of any combination of these basesheets. The basesheet may contain a binder, for example a non-dispersible binder, such as a latex binder or a cross-linkable binder; or a water-dispersible binder, such as a temperature-sensitve water dispersible binder or an ion-sensitive water dispersible binder. Ion-sensitive water-dispersible binders, such as those disclosed in the above-referenced co-pending patent applications, provide for water dispersibility of 80% or greater. Water dispersibility is defined as: 1 minus (the cross-direction wet tensile strength in water, divided by the original cross-direction wet tensile strength of the wet wipe), multiplied by 100%. Examples of individual webs include a melt-blown basesheet with a latex binder; a spun-bond basesheet with a temperature-sensitve water dispersible binder; and an airlaid basesheet with an ion-sensitve water dispersible binder.

The web is delivered to the wetting apparatus as a sheet of material. The web may be unwound from a roll, or it may be fed to the apparatus directly from a web making apparatus. The web may be a single sheet, or the web may have multiple sheets which are combined to form a multi-ply sheet. Multi-ply sheets may be bonded together, for example with adhesives, thermal bonding, sonic bonding, or hydroentanglement. Referring to FIG. 1, the web may be dispensed from a parent roll 4 which can be mounted on a rotating shaft 6. The spiral wind 16 of the parent roll allows the roll to be unwound in the direction of arrow 18. The unwinding of the roll can be controlled such that the web is dispensed at a consistent speed and tension even though the size of the roll is decreasing. The web is delivered in the form of a sheet to the wetting apparatus 35 in the direction of arrow 20. The delivery may be controlled by a series of rollers (8, 10, 12, 14, 22, 24) to adjust the speed of the delivery and/or the tension applied to the web. These rollers may independently be, for example, dancer rollers, idler rollers, draw rollers, or bowed rollers. The speed of the web may be at least 60 meters per minute (m/min). Preferably, the speed of the web is at least 80 m/min; more preferably at least 150 m/min; more preferably still at least 300 m/min; more preferably still at least 400 m/min.

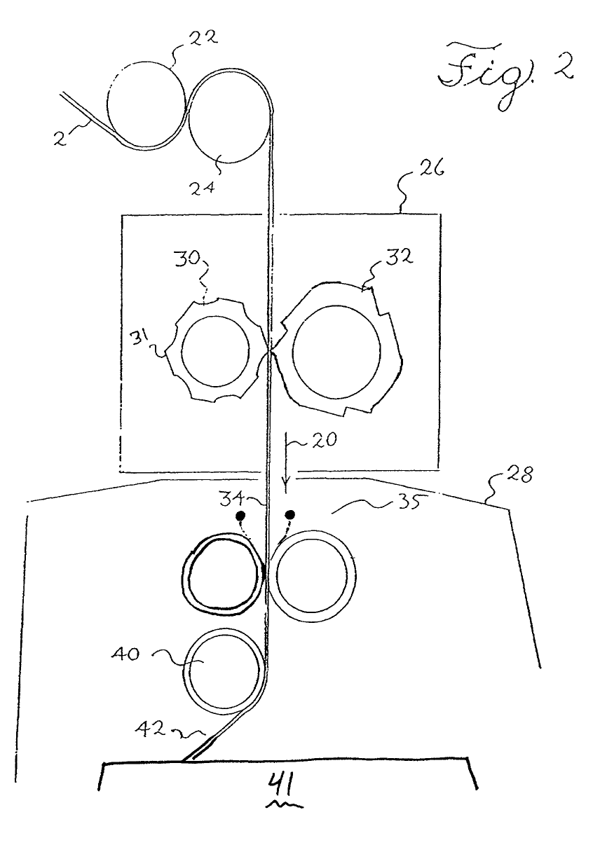

There may optionally be a device for perforating the web. Referring to FIG. 2, the perforation may be accomplished by a pair of rollers 30 and 32, wherein at least one of the rollers 30 comprises a series of teeth or blades 31 such that the impact of the rollers on the web results in incisions in a line forming a perforation line. The incisions within the perforation line may be spaced regularly, they may be spaced randomly, or they may be spaced in a controlled arrangement. The perforations are preferably in the cross direction (CD) of the web; that is in the plane of the web perpendicular to the direction of movement, or the machine direction (MD). The perforating rollers optionally may be contained in a housing 26, as illustrated in FIGS. 1-3.

The perforation may be accomplished by methods known to those skilled in the art. For example, a perforating apparatus as described in U.S. Pat. No. 5,125,302, incorporated herein by reference, may be used to perforate the web. The perforating apparatus may contain a rotating perforation roll and a stationary anvil bar. The perforation roll in this case has multiple rows of blades along the CD of the roll, and these blades protrude slightly from the face of the roll. The space between these rows and the length of the blades dictates the perforation length and spacing. The anvil bar is typically configured as a helix, for example a double helix or single helix, such that it contacts the perforation blades only at one or two positions at a time. Thus, as the perforation roll rotates, the web becomes perforated across the entire web. The web typically wraps the rotating perforation roll. The perforating apparatus may contain a rotating anvil roll with a stationary perforation blade. Typically, multiple anvil bars are configured in a helix around the anvil roll and engage the perforation blade. The web is perforated in one location at any one time. The web does not typically wrap either the anvil roll or the perforation blade. Also, the anvil roll may be kept stationary and the perforation blade may be rotated on a roll.

Referring to FIG. 2, a wetting solution may be applied to the web by wetting apparatus 35, and the wet web 42 is then delivered in the direction of arrow 20 to a processing apparatus 41. This delivery may be accomplished by the use of rollers or belts such as roller 40. Typically, care must be taken in handling the wet web since the presence of moisture in the web can alter the physical properties of the material. For example, incorporation of 225% by weight of a wetting solution can increase the percent elongation at failure (i.e. “stretch”) of a web from 5-10% to 25-40%. In general, the strength of the web is also decreased upon application of a given wetting solution. Typically, perforations also will diminish the strength of the wet web.

The processing apparatus may be any processing apparatus known to those skilled in the art. For example, the processing apparatus may be a slitting machine, a winding machine, a folding machine, or any combination of these. Typically, the processing apparatus provides for winding the web into logs or rolls. A winding apparatus may, for example, wind a web around a removable mandrel to produce a coreless material (U.S. Pat. Nos. 5,387,284; 5,271,515; 5,271,137; 3,856,226). The winding apparatus may, for example, wind a web around a tubular or cylindrical core (U.S. Pat. Nos. 6,129,304; 5,979,818; 5,368, 252; 5,248,106; 5,137,225; 4,487,377). The winding apparatus may, for example, be a coreless surface winder which can produce coreless rolls without the use of a mandrel. (U.S. Pat. Nos. 5,839,680; 5,690,296; 5,603,467; 5,542,622; 5,538,199; 5,402,960; 4,856,725). The above applications are incorporated herein by reference. The winding apparatus is preferably a surface winder which can wind a wet web into coreless logs. Such “wet winders” are described in copending application Ser. Nos. 09/900,516 and 09/900,746, both filed Jul. 6, 2001, the disclosures of which are incorporated by reference.

The wetting apparatus 35 and processing apparatus 41 may be enclosed in a containment box 28 to which the web 34 is delivered. Such a box serves to contain the wetting solution and to maintain a sanitary environment around the wet web. The area outside the box, including the dry components of the apparatus 1 and other equipment, is shielded from contact with the wetting solution. Thus, the workspace outside the box remains safe and easy to service. Containment of the wetting solution also provides for recovery of any excess solution that is not absorbed by the web. Recovered wetting solution may or may not be recycled depending on sanitary considerations. Excess wetting solution can be removed from the box by way of a drain. The drain can also provide for removal of any liquids used for cleaning the apparatus.

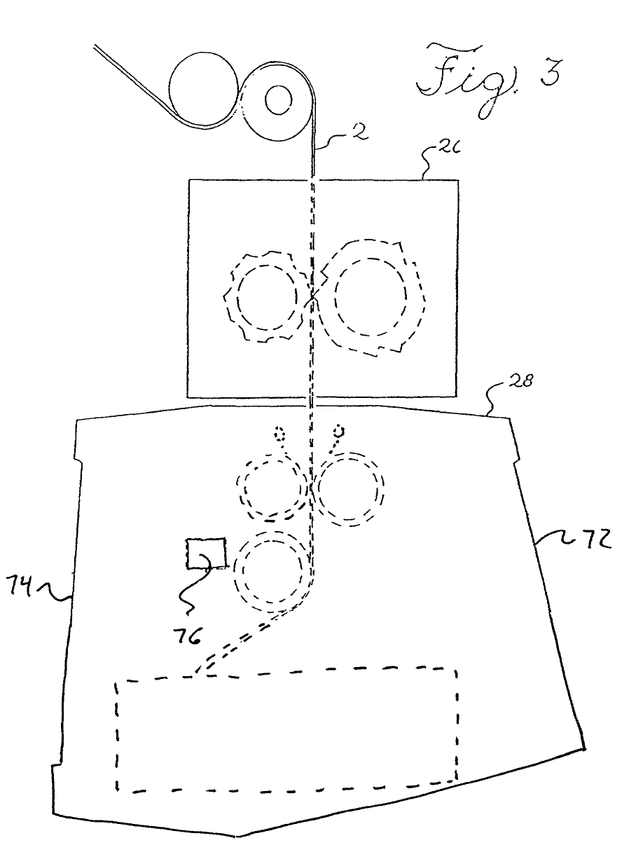

The setup of the wetting apparatus, the processing apparatus, and the containment box may be performed in an environment that is controlled to minimize airborne contaminants. The box can thus maintain the wetting and winding apparatus, the wet web, and the resultant wet rolls, in an environment which is substantially free of contaminants. Environmental parameters which may be controlled include air circulation and filtration, temperature, and humidity. The apparatus and the box may be sanitized on a periodic basis. The wetted areas inside the box may be treated with cleaning agents to eliminate any contamination, such as mold, fungus, or bacterial growth. The wetted areas may further be rinsed with clean, preferably ozonated, water, and then dried and/or treated with alcohol, such as isopropanol. Any components outside the box that come into contact with the basesheet are also preferably sprayed or wiped with alcohol. The size of the box may be large enough to allow access to the components inside the box, yet not so large that liquid could collect and contribute to contamination. In the embodiment illustrated in FIG. 3, physical access can be obtained by way of doors 72 and 74 on the sides of the box. The apparatus and the quality of the environment within the box may be monitored by way of corrosion-resistant windows 76, such as polycarbonate. The containment box may be constructed of any material which is not susceptible to corrosion, such as stainless steel. The box may be ventilated, depending on the characteristics of the wetting solution.

The wetting solution can be applied by methods known to those skilled in the art. Examples of wetting apparatus are disclosed in the above mentioned copending application Ser. Nos. 09/900,516 and 09/900,746. The wetting apparatus may contain, for example, a fluid distribution header, such as a die with a single orifice; a drool bar; a spray boom, such as a boom with multiple nozzles; or press rolls. The wetting apparatus may include the use of a nip to improve distribution and absorption. In other embodiments, the web may be passed through a bath or trough containing the wetting solution. The web may be wetted by contact with a material that is wet, such as a wetted belt or roller or a wet sponge. The application of solution may be accomplished in more than one step; that is by two or more wetting steps, which may be the same or different.

Numerous parameters may be controlled in order to influence the degree and/or rate of absorption of the wetting solution, as well as the amount of solution that is wasted and/or recycled. These parameters include, for example the solution add-on level, the temperature of the wetting solution, the geometry of impingement of the solution, and the pressure applied to the web during and/or after the solution application. Ideally, the wetting solution is applied evenly along the entire cross-direction of the web.

Examples of wetting solutions are given in the above mentioned U.S. application Ser. Nos. 09/564,449; 09/564,213; 09/565,125; 09/564,837; 09/564,939; 09/564,531; 09/564,268; 09/564,424; 09/564,780; 09/564,212; 09/565,623; 091223,999; and 09/900,698. Preferably, the wetting solution is added to the web with an add-on greater than about 25%. The amount of liquid or wetting solution contained within a given wet web can vary depending on factors including the type of basesheet, the type of liquid or solution being used, the wetting conditions employed, the type of container used to store the wet wipes, and the intended end use of the wet web. Typically, each wet web can contain from about 25 to about 600 weight percent and desirably from about 200 to about 400 weight percent liquid based on the dry weight of the web. To determine the liquid add-on, first the weight of a portion of dry web having specific dimensions is determined. The dry web corresponds to the basesheet which can be fed to the wetting and winding apparatus. Then, the amount of liquid by weight equal to a multiple (e.g. 1, 1.5, 2.5, 3.3, etc., times) where 1=100%, 2.5=250%, etc., of the portion of the dry web, or an increased amount of liquid measured as a percent add-on based on the weight of the dry web portion, is added to the web to make it moistened, and then referred to as a “wet” web. A wet web is defined as a web which contains a solution add-on between 25% and the maximum add-on which can be accepted by the web (i.e. saturation). Preferably, the wetting solution add-on is between about 25% and 700%; more preferably between 50% and 400%; more preferably still between 100% and 350%; more preferably still between 150% and 300%; more preferably still between 175% and 250%.

Complete absorption of the wetting solution helps to minimize the amount of excess liquid on the web and thus on the components of the apparatus. Incomplete absorption can be problematic even in the final wet product which is made from the wet web. It is desirable that the final wet product does not express liquid under normal handling and use, including packaging and dispensing. The wetting apparatus may be separated by a distance from the processing apparatus such that the wetting solution can be completely absorbed by the web as it travels between the apparatus. This travel time may range from less than one second to about one minute. The rate of absorption can depend on many factors, including the type of basesheet, the characteristics of the binder, and the composition used as the wetting solution.

The configurations of the wetting apparatus and processing apparatus may, however, be limited, for example by space constraints or other manufacturing considerations. If there is not a sufficient distance between the apparatus, it may be desirable that the wetting solution is absorbed in a shorter time than is necessary for absorption due to simple contact between the web and the wetting solution. Higher rates of absorption can allow for higher machine speeds and increased product throughput.

A fibrous web which has been treated with an ion-sensitive water-dispersible binder is typically hydrophobic. As used here in relation to substrates, “hydrophobic” or “nonwettable” describes fibers or surfaces of fibers that are not wetted by the aqueous liquids in contact with the fibers. The degree of wetting of the materials can be described in terms of contact angles and the surface tensions of the liquids and materials involved. Equipment and techniques suitable for measuring the wettability of particular fiber materials or blends of fiber materials can be provided by a Cahn SFA-222 Surface Force Analyzer System. When measured with this system, fibers having contact angles greater than 90° are “nonwettable”, ie, “hydrophobic”, and fibers having contact angles less than 90° are designated “wettable”, ie, “hydrophilic”.

A substrate or web which is hydrophobic tends to repel water-based substances, thus inhibiting the absorption of aqueous solutions into the web. If the applied wetting solution is not completely absorbed into the web, the web will not interact properly with the processing apparatus. For example, excess liquid on the surface of the web will function as a lubricant layer between the web and the components of the processing apparatus. This can make it difficult or impossible to process the web using frictional interactions, such as those employed by wet winding methods as described in the above mentioned co-pending application Ser. Nos. 09/900,516 and 09/900,746. Slow absorption can also cause processing problems. The properties of a wetted web are significantly different than those of a dry web, and the transition of a web from dry to wet can require precise control of the handling of the web. If the wetting solution takes too long to be absorbed into the web, the transition is made even more difficult due to the uncertainty in web characteristics.

A hydrophobic web material can absorb an aqueous wetting solution rapidly if the wetting solution is forced into the web by an applied pressure. Pressure can be applied to the web in a variety of ways, including the use of a pair of press rolls. These press rolls are analogous to the rolls used in size-press technology for applying binders during the formation of a web of material. Size presses are generally used to apply a binder, also referred to as a sizing material, to a fibrous web during the formation of the web. For example, the size press may apply the binder as the web precursor passes through the wet section of the web making machine. See, for example, U.S. Pat. Nos. 1,195,888; 2,257,113; 2,321,938; 3,097,968; 4,108,110; 4,565,155. The material which has been treated with the binder is then passed through a dryer to remove the moisture from the formed web. In some cases, size presses are used to squeeze water out of a web precursor at the end of the wet section of the web making machine (U.S. Pat. Nos. 4,556,454 and 5,501,775). A size press can also be used to regulate the moisture content of a web before drying, so that the drying process will be more reproducible (JP 05-209395 A2 and U.S. Pat. No. 5,401,315). Typically, conventional size presses are used to decrease the amount of liquid which is absorbed by a web, whereas the press rolls of the wetting apparatus are used to maximize the liquid which is absorbed by the web. Also, unlike conventional size presses, which apply additives to a web in the process of making a final dry product, the press rolls of the wetting apparatus apply a wetting solution to a dry sheet to provide a final product which is moist, for example containing at least 25% solution add-on.

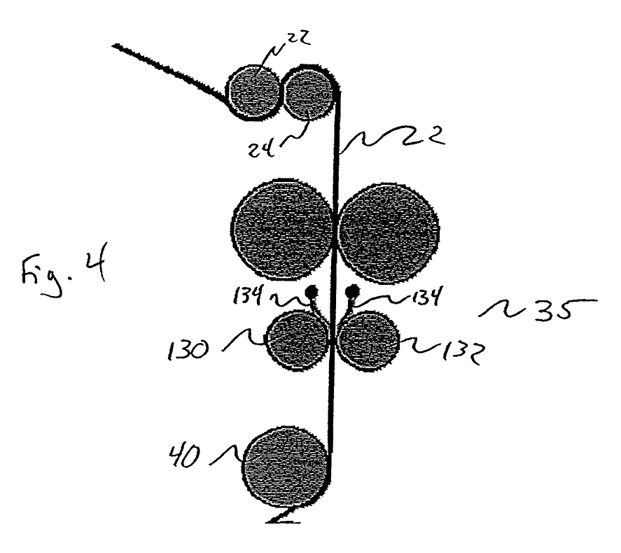

Referring to FIG. 4, the wetting apparatus may optionally include a set of press rolls. For example, the press rolls 130 and 132 may be rubber-covered rolls positioned to contact the web. The wetting solution 134 may be applied to the web, for example by a fluid distribution header or a spray boom. The wetting solution may also be applied to the press rolls, for example by a set of drool bars. The press rolls may be configured to apply force to the web, such that the solution is forced into the basesheet. This can help prevent a film of excess solution from forming on the surface of the sheet. The interaction of the press rolls with the web may be modified as needed to provide for complete solution absorption. For example, the press rolls may be removed from contact with the web if the absorption is sufficiently complete without added pressure. The press rolls may, for example, contact the web with a pressure that is controllable and which can be adjusted to modify the rate of absorption.

Preferably, the wetting apparatus includes two rubber covered press rolls which are driven to rotate on their respective axes. The rolls can be nipped, or they can be positioned to provide for a controlled gap between the rolls. The relative positioning of the rolls can be controlled by methods known to those skilled in the art, including air cylinders, servo motors, and cam arrangements.

The wetting solution may be dispensed through a drool bar having holes spaced along the entire width of the web. Preferably, the holes have a diameter of 3/32 inch and are spaced from each other by 3/8 inch. The wetting solution may be applied directly to the web, or it may be applied to the press rolls. The wetting solution may be applied from the drool bar to the press rolls. In this way, the liquid is allowed to spread out, and the motion of the rolls carries the solution to the nip, through which the web passes. The amount of solution applied can be controlled according to the operating speed of the web formation and/or the speed of processing.

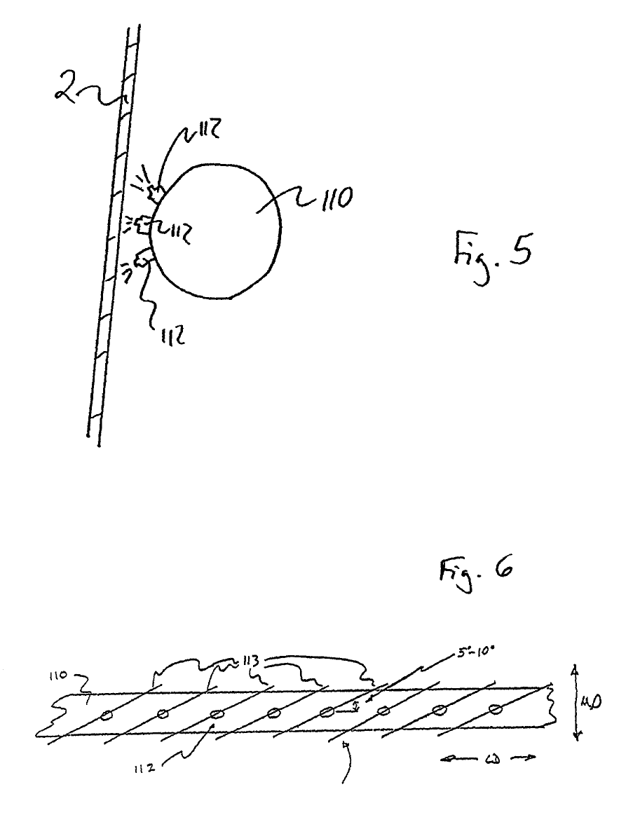

The wetting solution may be dispensed through a spray boom. The spray boom 110 may contain multiple nozzles 112 (FIG. 5). The distribution of the nozzles along the boom, as well as their orientation with respect to the web, may be adjusted to provide for substantially uniform application of liquid. For example, the spray boom may include a pipe which extends across the cross-direction of the web. This pipe may have nozzles across its length which spray the wetting solution onto the web. The distance between the individual nozzles and the distance between the nozzles and the web can affect the uniformity of application of the solution. It is desirable that the sprays from the nozzles do not interfere with each other when impinging the web. To help prevent this interference, it may be beneficial for the nozzles to be “shingled.” That is, the orientation of the nozzles may be rotated from being in line with each other in the cross-direction. Referring to FIG. 6, the nozzles 112 may be arranged in a single line and may be rotated 5-10 degrees from the cross-direction line so that the sprays 113 do not physically interfere with each other. The amount of solution delivered to the boom and its nozzles may be adjusted according to the speed of the web. Thus, a uniform amount of solution may be applied, not only in the cross-direction, but also in the machine-direction regardless of the speed of the web. For high machine speeds, it may be desirable to use nozzles having larger orifices and/or to utilize more than one spray boom. Multiple spray booms may be employed to deliver amounts of solution which are different or which are the same.

The press rolls may be covered with rubber, an elastomer, or any material which will assist in the spreading and the application of the wetting solution. Preferably, the roll cover has a hardness between 70 and 95 Shore A durometer and a thickness of about 20 mm. Preferably, the gap between the press rolls is between zero (i.e. nipped) and 0.75 mm. More preferably, the gap is between 0.2 mm and 0.7 mm.

The press roll wetting apparatus provides improved processing parameters compared to conventional wetting apparatus. The add-on levels for solution application facilitated by the press rolls can be 25% greater than those attainable by standard solution application techniques under the same conditions. In comparing the liquid add-on attainable by the press rolls to the add-on provided by conventional wetting processes, the web is characterized by a “conventional add-on.” The conventional add-on is defined as the maximum liquid add-on which can be absorbed under conventional wetting techniques without the use of press rolls. The add-on provided by the wetting apparatus including press rolls can be at least 15% greater than the conventional add-on. Preferably, the add-on provided by the use of press rolls is at least 25% greater than the conventional add-on, and more preferably is at least 30% greater than the conventional add-on. For example, in wetting identical hydrophobic webs at the same web speed and solution flow rates, a slot die wetting apparatus provided an add-on of 189%, whereas a press roll wetting apparatus provided an add-on of 252%, which is 33% greater than the conventional add-on.

The add-on level can be adjusted by modifying the operating parameters of the press roll wetting apparatus. For example, in wetting one type of hydrophobic web, the add-on was increased from 239% to 278% when the press roll gap was reduced from 0.40 mm to 0.13 mm. For another type of hydrophobic web, the add-on increased from 220% to 261% when the gap was reduced from 0.5 mm to no gap (nipped). Webs containing hydrophilic binders do not exhibit an increase in add-on when the press roll gap is decreased. The press roll wetting apparatus can be used to provide complete absorption of applied wetting solutions for operating speeds up to 300 meters per minute (m/min), preferably up to 330 m/min, more preferably up to 400 m/min.

The primary set of press rolls may be complemented by a secondary set of press rolls between the primary set and the processing apparatus. This secondary set of press rolls can provide for 100% absorption of the wetting solution for a given add-on target. The secondary set of press rolls can also serve to remove any unabsorbed solution from the surface of the web. This liquid can be removed from the rolls, for example with a doctor, such that the rolls are dry when they impinge on the web.

Advantages of using press rolls to provide for complete absorption of the wetting solution include increased friction of the wetted web, uniformity and reproducibility of the characteristics of the wetted web, and reductions in solution consumption and waste.

The application of a uniform amount of wetting solution to the web before processing the web can provide for a uniform distribution of ingredients throughout the web as well as the final product. This, in turn, can provide for consistent product quality and for consistent properties of an individual unit of product which may be purchased and used by a consumer. For example, in wet products made from a web with an ion-sensitive water-dispersible binder, an even distribution of an inorganic salt, such as sodium chloride (NaCl), potassium chloride (KCl) or potassium bromide (KBr), can ensure that any given portion of a wet product will disperse in water at an acceptable rate. Also, the presence of a uniform distribution of inorganic salt can ensure that none of the product will experience a decrease in wet strength, for example, during production, storage, or use. In another example, a set of preservatives may be used in the wetting solution to guard against contamination of the wet product. Insufficient preservative levels in a portion of the product can allow the presence and/or growth of contaminants, even if the remainder of the product is adequately protected. Accumulation of preservative in a portion of a product can cause the wet sheet to have an undesirable feel and/or wiping properties. An excess of preservative, in some areas of the sheet, could contribute to allergic or irritant contact dermatitis if that area was wiped on the skin. A uniform distribution of ingredients can prevent the occurrence of either of these extremes.

It is desirable to have even distribution of the wetting solution throughout the web in all directions. This homogenous wetting has many advantages. It can help to minimize or eliminate differences in physical properties within the web, such as strain and strength characteristics, allowing for reproducible processing of the wet product. It can help to minimize colonization and growth of contaminants. It can help to ensure consistent product quality; that is, a given roll or stack of wet wipes will have substantially the same characteristics as another roll or stack of wet wipes produced under specific operating conditions.

Even application of the wetting solution can help to provide uniform distribution of the ingredients initially present in the solution, such as dispersibility agents, preservatives, fragrances, or other additives. The distribution of ingredients may be uniform within the web of material in both the cross-direction and the machine-direction. Wet wipe products made from such a web then may also a uniform distribution of ingredients, and this uniformity may be consistent within a roll or stack (i.e. from the outside to the center, and from one end of the product to the other) or from one roll or stack to another. A uniform distribution of ingredients provides for consistent storage and dispensing characteristics of a set of wet wipes. For example, the entire roll or stack can be equally protected from contamination if there is uniform distribution of a preservative. In another example, a roll of wipes can be dispensed acceptably regardless of the number of sheets which remain in the roll. Dispensing characteristics include, for example, peel strength, tensile strength, and perf strength, as defined in the above mentioned U.S. application Ser. No. 09/659,307. These may be independently affected by the distribution of the wetting solution.

1. A method of wetting a web, comprising:
providing a hydrophobic web of material comprising a water-dispersible binder;
applying a wetting solution to the web; and
passing the web between a pair of press rolls.

2. The method of claim 1, wherein the wetting solution is applied at an add-on greater than about 25%.

3. The method of claim 1, wherein the wetting solution is applied at an add-on greater than about 100%.

4. The method of claim 1, wherein the wetting solution is applied at an add-on between about 25% and about 700%.

5. The method of claim 1, wherein the web retains a solution add-on greater than about 25%.

6. The method of claim 1, wherein the web travels at a speed of at least 60 meters per minute.

7. The method of claim 1, wherein the web of material has a conventional add-on, and the wetting solution is applied at an add-on which is at least 15% greater than the conventional add-on.

8. The method of claim 7, wherein the wetting solution is applied at an add-on which is at least 25% greater than the conventional add-on.

9. The method of claim 1, further comprising passing the web between a second pair of press rolls.

10. A method of wetting a web, comprising:
providing a web of material from a source;
controlling the draw of the web from the source;
perforating the web;
positioning the perforated web between a pair of press rolls; and
applying a wetting solution to the web with an add-on greater than about 25% to yield a wet web;
wherein the wet web retains a solution add-on greater than about 25%.

11. The method of claim 10, wherein the wetting solution is applied at an add-on between about 25% and about 700%.

12. The method of claim 10, wherein the wetting solution is applied at an add-on greater than about 100%.

13. The method of claim 10, wherein the web travels at a speed of at least 60 meters per minute.

14. The method of claim 10, wherein the web comprises a water-dispersible binder.

15. The method of claim 10, wherein the web is hydrophobic.

16. The method of claim 10, wherein the web of material has a conventional add-on, and the wetting solution is applied with an add-on which is at least 25% greater than the first add-on.

17. The method of claim 10, further comprising passing the web between a second pair of press rolls.

18. An apparatus for wetting a substrate, comprising:
a pair of press rolls; and
a solution applicator which delivers a wetting solution to a hydrophobic web comprising a water-dispersible binder;
wherein the web passing between the press rolls can absorb the solution with an add-on of at least about 25%.

19. The apparatus of claim 18, wherein the solution applicator is a spray boom.

20. The apparatus of claim 18, wherein the solution applicator is a drool bar.

21. The apparatus of claim 18, further comprising a fluid distribution header.

22. The apparatus of claim 18, wherein the press rolls are nipped.

23. The apparatus of claim 18, wherein the press rolls are separated by a distance of about 0.01 mm to about 1.0 mm.

24. The apparatus of claim 18, wherein each roll comprises a cover having a hardness of about 70 to about 95 Shore A durometer.

25. The apparatus of claim 18, further comprising a second pair of press rolls.

26. The apparatus of claim 18, wherein the web has a conventional add-on, and the web passing between the press rolls can absorb the solution at an add-on which is at least 25% greater than the conventional add-on.

27. The apparatus of claim 18, wherein the solution applicator delivers the wetting solution directly to the web.

28. The apparatus of claim 18, wherein the solution applicator delivers the wetting solution by depositing the solution onto the press rolls.
